(19) United States
(12) Patent Application Publication
(10) Pub. No.: US 2024/0237069 A1
(43) Pub. Date: Jul. 11, 2024

(54) Adaption of Contention Window for Back-Off Time in Distributed Coordinate Function (DCF)

(71) Applicant: Vestel Elektronik Sanayi ve Ticaret A. S., Manisa (TR)

(72) Inventors: Abdelrahman Ali Marzouq Abushattal, Istanbul (TR); Musab Mahmoud Abd Alkareem Alayasra, Istanbul (TR); Hüseyin Arslan, Istanbul (TR)

(21) Appl. No.: 18/576,770

(22) PCT Filed: Jul. 7, 2021
(86) PCT No.: PCT/EP2021/068872

§ 371 Date: Jan. 5, 2024

(51) Int. Cl. H04W 74/0816; H04W 74/08; H04W 84/12

(52) U.S. Cl. CPC H04W 74/0816; H04W 74/0866; H04W 84/12

(57) ABSTRACT

Methods and apparatuses are described to determine a contention window for a back-off timer in a communication device transmitting a signal. The value of the back-off timer is chosen from the range of the contention window. The method selects a future contention window range having increased upper and lower bounds compared to a current contention window range. After a successful transmission a future contention window is chosen randomly from the previous contention windows. The future contention window range may be chosen such that previous contention windows are excluded.

### CROSS-REFERENCE TO RELATED APPLICATION

This application is the United States national phase of International Application No. PCT/EP2021/068872 filed Jul. 7, 2021, the disclosure of which is hereby incorporated by reference in its entirety.

### BACKGROUND

### Technical Field

The present disclosure relates to adapting the size of a contention window used to determine a back-off timer in a contention based transmission.

### Technical Considerations

Wireless communication has been advancing over several decades now. Exemplary notable standards organizations include the 3rd Generation Partnership Project (3GPP) and IEEE 802.11, commonly referred to as Wi-Fi.

In IEEE 802.11 WLAN standards, the Distributed Coordination Function (DCF) adopt Carrier Sense Multiple Access with Collision Avoidance (CSMA/CA) with a random binary back-off scheme for the channel access, since collision occurrence is one of the reasons for degradation of the average throughput in the WLAN network.

### SUMMARY

The present disclosure relates to methods and apparatuses for adapting the size of a contention window used to determine a back-off timer in a contention based transmission.

According to an embodiment, a method is provided for a determination of a contention window for a back-off timer in a communication device transmitting a signal, comprising: after detecting a collision, selecting a future contention window range having an increased lower bound and an increased upper bound with respect to a lower bound and an upper bound of a current contention window range; and after a successful transmission, choosing randomly one contention window range from a set of previous contention window ranges as a future contention window range.

According to an embodiment, a method is provided for determining the value of a back-off timer in a communication device transmitting a signal, comprising determining of a range of a contention window according to the method described above; selecting a value of the back-off timer in the range; and transmitting the signal when the back-off timer has expired.

According to an embodiment, an apparatus is provided for a determination of a contention window for a back-off timer in a communication device transmitting a signal, comprising: processing circuitry configured to: after detecting a collision, select a future contention window range having an increased lower bound and an increased upper bound with respect to a lower bound and an upper bound of a current contention window range; and after a successful transmission, choose randomly one contention window range from a set of previous contention window ranges as a future contention window range.

According to an embodiment, a communication device is provided for determining the value of a back-off timer, comprising: an apparatus as described above, wherein the processing circuitry is further configured to: select a value of the back-off timer in the contention window range; and configured to transmit a signal when the back-off timer has expired.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

An understanding of the nature and advantages of various embodiments may be realized by reference to the following figures.

FIG. 1 is a block diagram illustrating a communication system;

FIG. 2 is a block diagram illustrating a transmitting and/or receiving device;

FIG. 3A is a schematic drawing illustrating accessing a channel in basic mode;

FIG. 3B is a schematic drawing illustrating accessing a channel in RTS/CTS mode;

FIG. 4 is a schematic drawing illustrating a back-off process of multiple stations accessing a channel;

FIG. 5 is a flow diagram illustrating exemplary steps of a transmission using a back-off timer;

FIG. 6A is a schematic drawing illustrating a basic selection of contention window ranges;

FIG. 6B is a schematic drawing illustrating an improved selection of contention window ranges;

FIG. 7 is a flow diagram illustrating exemplary steps of selecting a contention window range; and

FIG. 8 is a graph showing simulation results illustrating throughput for an exemplary implementation.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

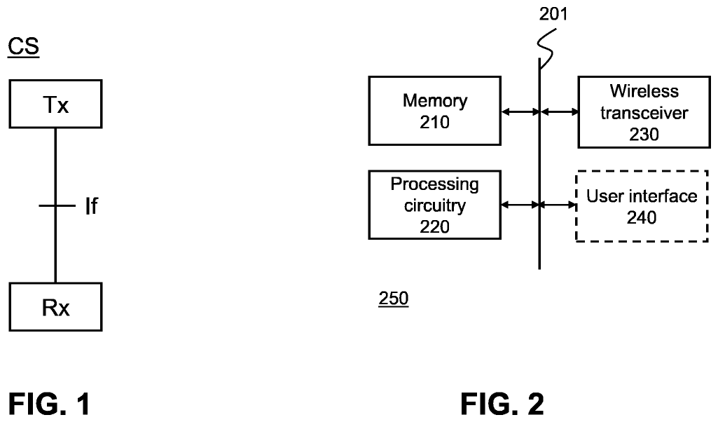

FIG. 1 illustrates an exemplary communication system CS in which Tx represents a transmitter and Rx represents a receiver. The transmitter Tx is capable of transmitting a signal to the receiver Rx over an interface If. The interface may be, for instance, a wireless interface. The interface may be specified by means of resources, which can be used for the transmission and reception by the transmitter Tx and the receiver Rx. Such resources may be defined in one or more (or all) of the time domain, frequency domain, code domain, and space domain. It is noted that in general, the “transmitter” and “receiver” may be also both integrated in the same device. In other words, the devices Tx and Rx in FIG. 1 may respectively also include the functionality of the Rx and Tx.

The present disclosure is not limited to any particular transmitter Tx, receiver Rx and/or interface If implementation. However, it may be applied readily to some existing communication systems as well as to the extensions of such systems, or to new communication systems. Exemplary existing communication systems may be, for instance the IEEE 802.11 based systems such as the recently studied IEEE 802.11be or the like.

IEEE 802.11, commonly referred to as Wi-Fi, has been around for three decades and has become arguably one of the most popular wireless communication standards with billions of devices supporting more than half of the worldwide wireless traffic. The increasing user demands in terms of throughput, capacity, latency, spectrum and power efficiency calls for updates or amendments to the standard to keep up with them. As such, Wi-Fi generally has a new amendment after every 5 years with its own characteristic features. In the earlier generations, the focus was primarily higher data rates, but with ever increasing density of devices, area efficiency has become a major concern for Wi-Fi networks. Due to this issue, the last (802.11ax) and upcoming (802.11be) amendments have focused more on the efficiency issue.

Multi-AP coordination and multi-link operation (MLO) are two features proposed to improve the performance of Wi-Fi networks in the upcoming IEEE 802.11be amendment. Multi-AP coordination is directed toward utilizing (distributed) coordination between different APs to reduce inter-BSS (basic service set) interference for improved spectrum utilization in dense deployments. MLO, on the other hand, supports high data rates and low latency by leveraging flexible resource utilization offered by the use of multiple links for the same device.

Multi-access point (AP) coordination is quite similar in principle to the coordinated multipoint (CoMP) concept proposed for cellular networks proposed and standardized in 3rd Generation Partnership Project (3GPP) Rel-11. The clustering mechanism of COMP is related to the group formation addressed in this disclosure. Moreover, the different coordination schemes being discussed in IEEE 802.11be amendment, also referred to as Wi-Fi 7, have their roots in the CoMP schemes.

Exemplary coordination schemes in Wi-Fi include CSR (coordinated spatial reuse), Co-OFDMA (coordinated OFDMA), CBF (coordinated beamforming), or JT (Joint Transmission). CSR may be used when inter-BSS (Basic Service Set) interference is weak, but the channel is perceived as busy. In Co-OFDMA, APs may coordinate their schedules in time and frequency. In CBF (or “Null-Steering”) an AP targets to null its interference to neighboring STAs while forming beams to its served STA(s). In JT, (Joint Transmission or “Joint Transmission and Reception”), multiple APs may serve the same STA by creating a dynamic distributed MU-MIMO system.

In general, a mechanism for AP grouping or clustering focuses on methods and processes of exchanging information and/or signaling between the coordinating nodes. Some approaches evolve around the indication of distributed multiple-input multiple-output (MIMO) capability of an AP to other APs in its coverage area or, similarly, consider “master” AP as the one responsible for transmitting messages advertising the multi-AP group and signaling exchanges related to other APs joining the group. Further, group formation is studied from the group identification perspective.

Wi-Fi 7 introduces the concept of multi-link operation (MLO), which gives the devices (APs and STAs) the capability to work on operate on multiple links (or even bands) at the same time. MLO introduces a new paradigm to multi-AP coordination which was not part of the earlier coordination approaches.

Multi-link operation (MLO) is considered in Wi-Fi-7 to improve the throughput of the network and address the latency issues by allowing devices to use multiple links. Multi-band considers multiple links operating in different frequency bands (2.4 GHZ, 5 GHZ, 6GHZ and 7 GHz bands, for instance) while multi-channel under MLO considers the use of multiple channels within the same band.

The multi-link transmission could be category as simultaneously transmit and receive (STR) and non-STR mode. On the STR mode, the access point (AP)-MLD transmit frames and receive frames on multi-link at the same time and the multi-link assume to center frequency are far enough where no intra-interference between these multi-links.

In the Single-Link Access (SLA) the back-off timer only considers the primary link to accessing to channel even without the back-off auxiliary timer reaches zero. For Multi-Link Access with the Shortest Backoff (MLA-S) unlike SLA, all active links may access the channel and operate as the primary link. The first active link that finishes his back-off time will be considered as primary and the other as auxiliary links. On the other hand, Multi-Link Access with the Longest Back-off (MLA-L) accesses to the channel when all active link back-off timer are finished, and the last channel and the last station back-off timer become zero. The link with the largest back-off timer is considered the primary link. For Multi-Link Access with End-Time Alignment (MLA-A) the first link to finish the back-off timer is considered as the primary link and the auxiliary link may be accessed when the respective back-off timer becomes zero.

A multi-link device (MLD) may have several “affiliated” devices, each affiliated having a separate PHY interface, and the MLD having a single link to the LLC (Logical Link Control) layer. In the proposed IEEE 802.11be draft, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11be™/D1.01, June 2021, section 3.2). Connection(s) with an MLD on the affiliated devices may occur independently or jointly.

A preliminary definition and scope of a multi-link element is described in section 9.4.2.247b of aforementioned IEEE 802.11be draft. An idea behind this information element/container is to provide a way for multi-link devices (MLDs) to share the capabilities of different links with each other and facilitate the discovery and association processes. However, this information element may still be changed or new mechanisms may be introduced to share the MLO information.

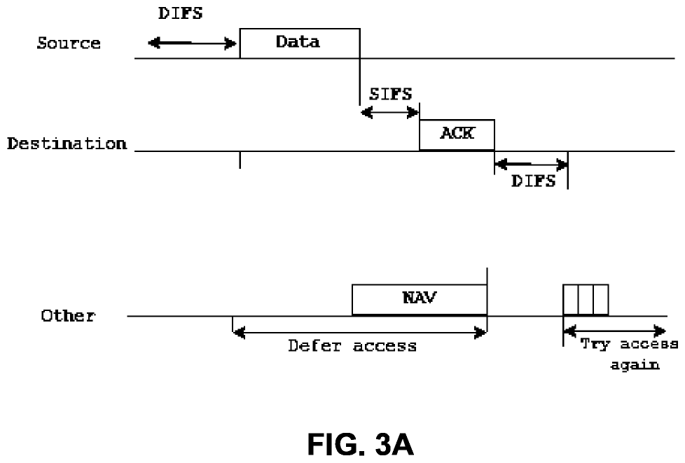

FIG. 2 illustrates a transmitting device 250 according to some exemplary embodiments. The transmitting device 250 may be a part of any wireless communication device such as STA or AP, or, in general base station or terminal. The transmitting device 250 comprises memory 210, processing circuitry 220, and a wireless transceiver 230 (or a wireless transmitter), which may be capable of communicating with each other via a bus 201. The transmitting device 250 may further include a user interface 240. However, for some applications, the user interface 240 is not necessary (for instance some devices for machine-to-machine communications or the like).

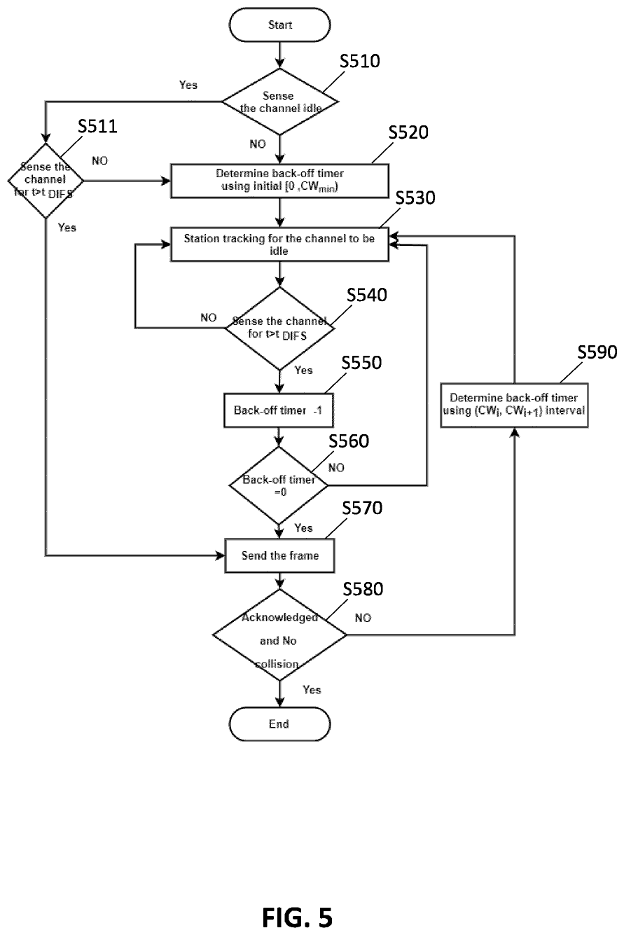

The memory 210 may store a plurality of firmware or software modules, which implement some embodiments of the present disclosure. The memory may 210 be read from by the processing circuitry 220. Thereby, the processing circuitry may be configured to carry out the firmware/software implementing the embodiments. The processing circuitry 220 may include one or more processors, which, in operation, may perform the method steps shown in FIG. 5. The wireless transceiver 230, in operation, transmits the generated transmission signal.

The IEEE 802.11 standard provides details for both the Physical Layer (PHY) and the Medium Access Control (MAC) related to WLAN.

For the MAC there are two medium access coordination functions: the fundamental contention-based Distributed Coordination Function (DCF) and optional Point Coordination Function (PCF). In PCF, the access point AP ensures free-collision service by coordinating with the stations in the network using polling messages. On the other hand, the active stations in DCF contend for channel resource access using Carrier Sense Multiple Access with Collision Avoidance (CSMA/CA).

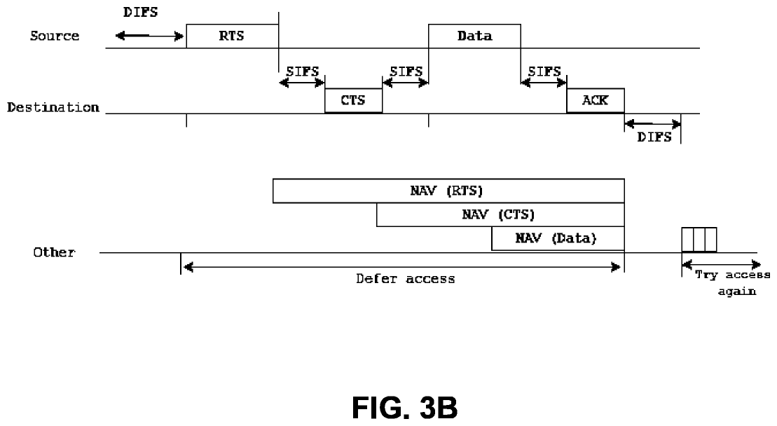

In CSMA/CA, there are two access modes: basic mode and Request-to-send/clear-to-send (RTS/CTS) mode. In the basic mode shown in FIG. 3A a source station senses the channel and automatically sends a data frame if the channel is idle for a time longer than a DCF Interframe Space (DIFS) interval. The station awaits receipt of an acknowledgement (ACK) packet from the destination to indicate the packet was received correctly. If such acknowledgement does not arrive in a timely manner, it assumes the packet collided with some other transmission, causing the node to enter a period of back-off prior to attempting to re-transmit.

In the RTS/CTS mode shown in FIG. 3B, the station defers the transmission for a random back-off time while in RTS/CTS mode. A station sends an RTS frame when making sure the channel being idle for a period greater than DIFS else it delays the transmission for a random back-off period. The destination station sends a CTS frame after waiting for the Short Inter Frame Space (SIFS) interval and then the source station sends the data frame.

Such a back-off period is determined by a back-off timer. Each time a station senses the channel idle for a period greater than DIFS while being in the back-off period, the value of the back-off timer is reduced by one unit of the timer.

In both modes, if the source station did not receive the Acknowledgement (ACK) frame from the destination for a period longer than SIFS, it will assume that there is a collision and schedule retransmission for a random back-off time. In both access modes, all other stations will defer accessing the channel for the time that the channel is considered busy according to Network Allocation Vector (NAV).

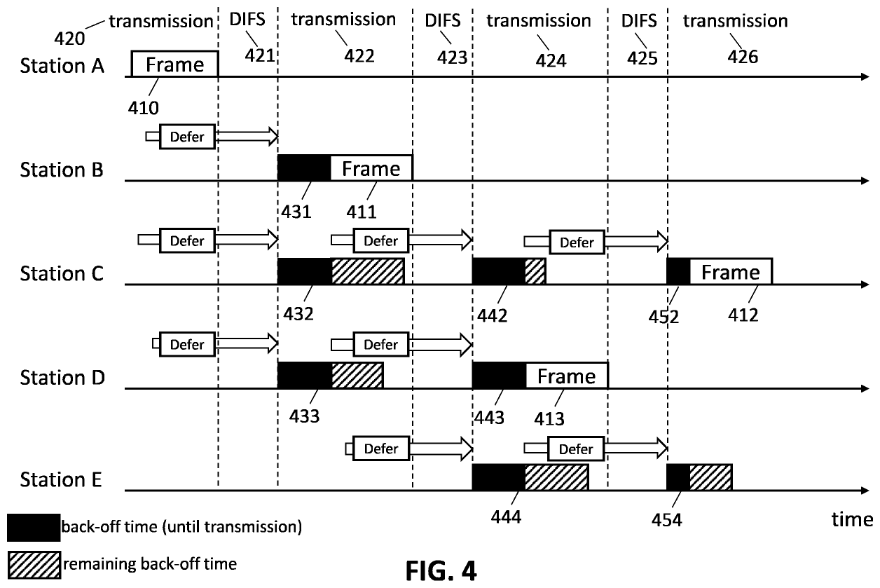

An exemplary back-off procedure is illustrated in FIG. 4. It shows five stations A to E in the same network. Station A transmits a frame 410 in a first transmission time period 420. Stations B to D have data to be sent and thus sense the channel in the first transmission time period. They detect that the channel is not being idle and defer accessing the channel. After sensing the channel idle for a period greater than DIFS 421, stations B to D wait for their respective back-off periods 431-433. As station B has the shortest back-off time 431 in this example, station B transmits a frame 411, while stations C and D sense the channel as busy and thus defer accessing the channel in a second transmission time period 422. Deferring here means that the transmitting station does not need to sense the channel and will not transmit data in the channel for a certain time as the channel is being used by another station. The DIFS in the present example may be defined as in the IEEE 802.11 standard family. In IEEE 802.11 standard family, a station must sense the status of the wireless medium before transmitting. If it finds that the medium is continuously idle for the DIFS duration (which is a predefined duration specified by the respective standard), it is then permitted to transmit a frame. If the channel is found busy during the DIFS interval, the station should defer its transmission.

Now, station E has also data for transmission and tries to access the channel in the second transmission time period 422. As the channel is busy due to the transmission of the frame 411, station E also defers from transmitting its data. After sensing the channel idle for a period greater than DIFS 423, stations C and D wait for their respective remaining back-off periods 442, 443. Station E initializes its back-off timer 444. Station D, having a shortest back-off period 433 among the stations competing for the channel in the third transmission time period 424, transmits a frame 413 after waiting for the back-off period 443. Stations C and E defer access and use their respective back-off time 452, 454 after sensing the channel idle again for DIFS 425. The back-off times 452, 454 of stations C and E correspond to the remaining back-off times of the third transmission period 424. Station C transmits a frame 412 in a fourth transmission time period 426, when the corresponding back-off timer 452 has expired (e.g. reached zero when counting down).

An exemplary process for transmitting a frame by a transmitting station (such as any of the stations A to E mentioned above) is depicted in FIG. 5. The frame may be a data frame as in FIG. 3A or a control frame, e.g. an RTS frame as in FIG. 3B. The transmitting station starts sensing S510 the channel. If the channel is sensed idle (“yes” in step S510) and further sensed idle S511 for a time period greater than DIFS (“yes” in step S511), the frame is transmitted S570. If an ACK is received for data transmission in step S580 or if there was no collision corresponding to reception of CTS after an RTS transmission, the transmission was successful (“yes” in step S580) and the frame transmission process ends. If the channel is not sensed idle (“no” in step S510) or the idle time is not greater than DIFS (“no” in step S511), a back-off timer is determined S520 within an initial window [0, CWₘᵢₙ). CWₘᵢₙ is a predefined minimal upper bound of the initial contention window range. The window may include an integer amount of possible (selectable) back-off timer values. The back-off timer may be determined (selected) randomly out of the initial window as explained above. In an exemplary implementation, the selection may be performed by using a uniform probability for each value within said interval. In other implementations, a non-uniform probability distribution for selecting a value of the back-off timer out of the (initial) contention window may be employed.

In step S530, the transmitting station tracks the channel, in particular to determine whether it becomes and remains idle. If the channel is sensed idle S540 for a period greater than DIFS (“yes” in step S540), the value of the back-off timer is reduced by 1 in step S550. If the channel is sensed busy (“no” in step S540), the station continues tracking the channel in step S530. Herein, the term “tracking” refers to monitoring the channel which may include sensing and tracking the time periods in which the channel access is deferred or the like.

In the case, the back-off timer has not yet expired, i.e. is not equal to zero (“no” in step S560), steps S530 to S560 are repeated. In the case, the back-off timer is equal to zero (“yes” in step S560), the frame is transmitted S570. The transmission was successful after receiving a corresponding indication from the receiving side, for example an ACK packet. In such case (“yes” in step S580), as mentioned above, the exemplary process for transmitting the frame ends.

If the transmission was not successful, e.g., no ACK or a negative ACK for transmitted user data or CTS for transmitted RTS has been received (“no” in step S580), a collision is assumed. In such case, a back-off timer is chosen from a new contention window in step S590 and steps S530 to S580 are repeated.

The Contention Window (CW) is for determining the value of the back-off timer. The value of the back-off timer is taken from the CW range. The value is picked, for example, in the range [0, CWᵢ) with a uniformly distributed probability function as following:

$$f ( x ) = \{ \begin{matrix}\frac{1}{{CW}_{i}} & for 0 < x < {CW}_{i} \\ 0 & elsewhere\end{matrix}$$

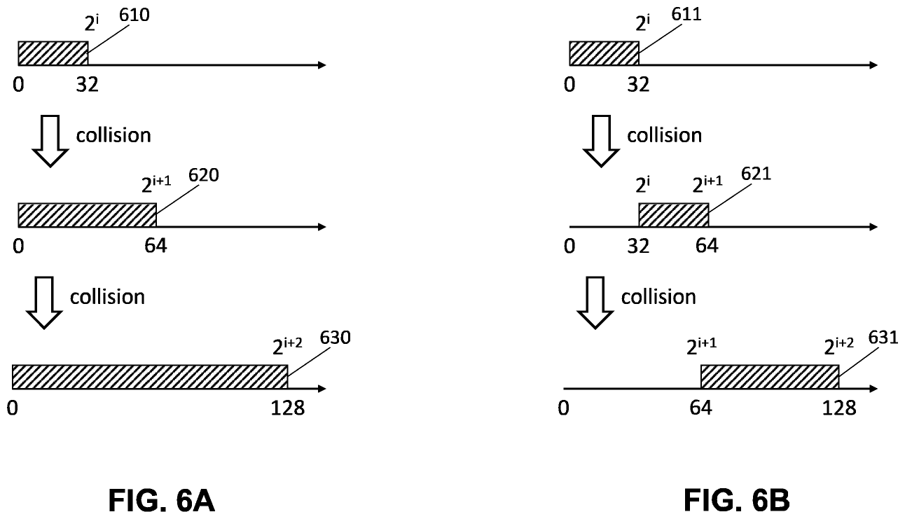

However the present disclosure is not limited to uniform probability distribution functions (PDFs), any other PDF may be used. In an exemplary implementation, after each time a station experiences a collision, the CW range will be increased. For example, the CW range may be doubled to reduce the probability of collision that occurs between multiple (two or more) stations transmitting simultaneously. This method is called Binary Exponential Back-off (BEB), which is shown exemplarily in FIG. 6A. In FIG. 6A, the initial CW range CWₘᵢₙ 610 in this example is [0, 32). Any value of the back-off timer from this range (from 0 to 31) can be represented by 5 bits. After detecting a collision, the CW range is extended to [0, 64) 620 (representable by six bits) and after a second collision finally to [0, 128) 630 (representable by seven bits). However, the present disclosure is not limited to an extension of the contention window in binary steps. Any other extension of the contention window interval may be used. In summary, in FIG. 6A, after a collision, the contention window size is increased by doubling the upper bound of the contention window while maintaining the lower bound (0). Each time a transmitting station senses the channel idle for a period greater than DIFS, the back-off timer value may be chosen from the CWₘᵢₙ again. However, such a sharp reduction may cause degradation in the performance of the network that contains a large number of stations.

FIG. 6B shows exemplarily an approach for choosing a contention window range in case of a collision. Unlike in FIG. 6A, in FIG. 6B the lower bound is shifted after a collision. In addition, the range from the lower bound to the upper bound may increase, e.g., double.

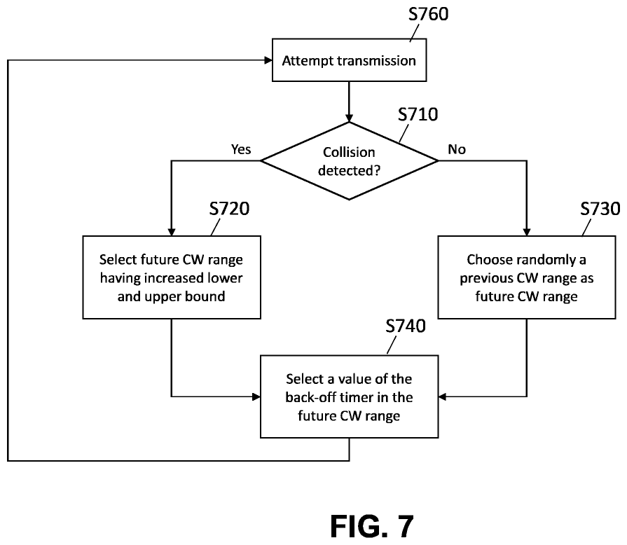

An exemplary flowchart of a method which may be performed by a wireless station (transmitting station) is depicted in FIG. 7. In step S760, transmission is attempted. This may be performed in various different ways depending on the contention protocol and type of data transmitted. For example, channel sensing which detects a busy channel and results in deferring channel access may be considered as an unsuccessful attempt to transmit data. Reception of a negative acknowledgement (NACK) after transmitting the data may be considered as an unsuccessful attempt to transmit data. In some systems, not receiving an ACK within an expected time period may be considered as an unsuccessful attempt to transmit data. Another unsuccessful attempt to transmit data may be not receiving a CTS after transmitting an RTS or the like. In other words, a station experiencing any of the mentioned unsuccessful attempts may be considered as experiencing collisions with other stations competing for transmitting through the same channel.

After detecting a collision (“yes” in step S710), a first future CW range 631 [CWᵢ₊₂, CWᵢ₊₃) is chosen S720. Said future CW range has an increased lower bound and an increased upper bound compared to a current CW range 621 [CWᵢ, CWᵢ₊₁), i.e. CWᵢ<CWᵢ₊₂ and CWᵢ₊₁<CWᵢ₊₃. If no collision has been detected by the station so far, the current CW range may be the initial CW range 611. After successfully transmitting a frame (“no” in step S710), the station chooses a second future CW range for the next transmission. Said second future CW range after a successful transmission is chosen from a set of previous CW ranges in step S730. A previous CW range [CWₖ, CWₖ₊₁) has a lower index k compared to a current CW range [CWᵢ, CWᵢ₊₁) having index i, i.e., k<i. In other words, the term “previous CW range” refers to a CW range with an index preceding (or, in some implementations, an index preceding or equal to) the index of the current CW range. The choosing of the future CW range after a successful transmission can be performed randomly, which in this context may mean pseudo-randomly (e.g. using a pseudo-random generator).

However, it is conceivable, instead of a random choice, to choose the future CW range according to a predefined rule. For example, by selecting CW range with an index immediately preceding the current index (index of the current CW) or by selecting CW range with an index offset by a predetermined amount from the current index (e.g. by 2 or 3 or the like).

For example, in FIG. 6B in the case the current CW is [64, 128), the future CW range may be any of the ranges [0, 32) or [32, 64). This may avoid the above-mentioned sharp reductions as not all stations will return to CWₘᵢₙ and thus enables a better performance of the network.

The future CW range 631 and the current CW range 621 may be non-overlapping. By excluding currently and previously used ranges, the back-off timer may be chosen from the additionally available values and thus the probability for collisions may be reduced. Each of the previous, current and future ranges may be non-overlapping with any of the other previous, current and future ranges, i.e., for all consecutive ranges [CWᵢ, CWᵢ₊₁) and [CWᵢ₊₂, CWᵢ₊₃) the relation CWᵢ₊₁≤CWᵢ₊₂ may be fulfilled for all ranges i. For all consecutive ranges the upper bound of a range is smaller or equal to the lower bound of the directly following range. The example in FIG. 6B shows this exemplarily for the three ranges [0, 2ⁱ), [2ⁱ, 2ⁱ⁺¹) and [2ⁱ⁺¹, 2ⁱ⁺²). However, the present disclosure is not limited to binary values for the upper and lower bounds. Using binary values is advantageous

Non-overlapping CW ranges may be achieved by choosing the upper bound CWᵢ₊₁ of the current CW range 621 [CWᵢ, CWᵢ₊₁) as lower bound of the future CW range 631 [CWᵢ₊₁, CWᵢ₊₃). This is illustrated by the example in FIG. 6B that has been explained above. However, it is noted that the present disclosure is not limited to non-overlapping ranges. It is conceivable to provide partly overlapping CW ranges, or CW ranges which consist of two or more smaller CW ranges.

In order to further reduce collision probability the range of the future contention window 631 may be chosen larger than the range of the current contention window 621. For example, the upper bound of the future CW range 631 may be set to twice the upper bound of the current contention window 621. Said behavior may be limited by introducing a maximal value for either the upper bound or the size of the contention window. After such maximum value of the upper bound or the size of the CW window is reached, the CW is no longer allowed to grow. The CW may thus stay the same or may be selected randomly out of the set of all possible (previous) CW ranges.

A predefined maximum value for the increased upper bound of the future CW range 631 may exist. The maximum size of the contention window may be given by CWᵢ<CWₘₐₓ for all values of i. In the exemplary implementation in FIG. 6B such a predefined maximum range may be chosen for example as 512 or 1024. However, the present application is not limited to these exemplary values. Such a predefined maximum may, for example, be set by a standard or be configured by a control protocol of a device as an access point or a station or the like.

A station accessing a channel may initialize its current contention window range with the minimum contention window range 611 [0, CWₘᵢₙ). Said station may use the minimum contention window 611 for initialization when accessing a channel for a first time or when accessing a channel again after a predefined amount of time. Such a predefined amount of time may, for example, be set by a standard or be configured by a control protocol of a device as an access point or a station or the like.

After a successful transmission using for example the contention window [CWᵢ, CWᵢ₊₁), the station selects a future CW range from a set of previous CW ranges. The set of previous CW ranges may include the intervals [CWₖ, CWₖ₊₁) that have an index k lower than index i of the current contention window, i.e. 0≤k<i. The set of previous CW ranges may for example, include the previous contention windows [CWᵢ₋₃, CWᵢ₋₂), [CWⁱ⁻², CWᵢ₋₁) and [CWᵢ₋₁, CWᵢ). Said set may exclude the minimum CW 611 [0, CWₘᵢₙ). Excluding the minimum contention window further reduces collision probability, especially when a plurality of stations is accessing a channel.

A set of previous contention windows may be available for a successful transmission following detecting a collision. Following detecting a collision means that there has been at least one collision such that the current CW range is not the minimum CW range before (not necessarily immediately before) the successful transmission.

For example, a station starts with a minimum contention window [0, 2⁵). In case there is no collision, the station may continue to use the range [0, 2⁵) as current CW range. If there is a collision, the station may increase the current CW range to [2⁵, 2⁶). After detecting several collisions the station may have increased the current CW range to [2⁸, 2⁹). In this example, the set of previous contention window ranges may include the intervals [2ⁱ, 2ⁱ⁺¹) with 5≤i≤7 (or, in some embodiments, 5≤i≤8) and the minimum CW range has been excluded from the set. After one or more successful transmissions following detecting collisions, the station may reduce the current CW range, for example by a random selection out of the previous window ranges, to [2⁵, 2⁶). Two or more of said successful transmissions following detecting collisions may be directly consecutive successful transmissions. After another successful transmission in this example, the station may continue using [2⁵, 2⁶), as the set of previous CW ranges excluding the minimum CW range is an empty set. In such a special case, in some exemplary implementations, the station may alternatively reduce the current CW range to the minimum CW range [0, 2⁵).

A successful transmission may be any successful transmission following detecting the collision within a predefined time or after a predefined number of successful transmissions.

The determination of the contention window range may be applied in any of the current and future IEEE 802.11 based communication systems, such as IEEE 802.11ax or IEEE 802.11be or the like. However, the present disclosure is not limited to IEEE 802.11 based communication systems and it may be applied to some existing communication systems as well as to the extensions of such systems, or to new communication systems.

A back-off timer may be determined using the determination of the CW range as explained above and selecting the value of the back-off timer in said range S740. The selection may use a uniform probability distribution or any non-uniform probability distribution.

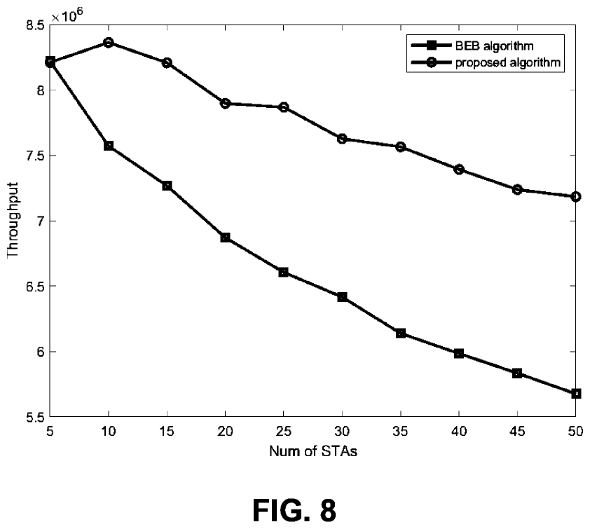

For the basic access mode as shown in FIG. 3A, the CW scheme according to the present disclosure provides better performance compared to the Binary Exponential Back-off (BEB) CW algorithm due to the reduction of the probability of the collision between the stations. Collisions cause a decrease in network throughput performance. This can be seen from the results of an exemplary implementation in FIG. 8, the more stations (STA) there are, the higher the probability of collision, which leads to a decrease in network throughput performance. FIG. 8 shows results of simulations in which the x axis represents number of stations competing and y axis represents throughput in bits per second. The exemplary simulation of FIG. 8 used following parameters:
Transmission rate: 11 Mbps,
Slot time: 20 μs,
SIFS: 25 μs,
DIFS: 50 μs,
CWₘᵢₙ: 32,
ACK: 112 bits+PHY header,
RTS: 160 bits+PHY header,
CTS: 112 bits+PHY header.

The selection of the contention window according to the present disclosure may provide an increased throughput in the exemplary simulation compared to the BEB algorithm.

The concept of multi-link operation (MLO), as explained above, gives the devices (APs and STAs) the capability to work on operate on multiple links (or even bands) at the same time. This may introduce a plurality of back-off timers, one for each link. Said back-off timers may use the determination of contention windows as explained above. As mentioned above, the back-off timers in the respective links may be used to determine the primary link and respective one or more auxiliary links in the MLO.

### Implementations in Software and Hardware

The methodologies described herein may be implemented by various means depending upon the application. For example, these methodologies may be implemented in hardware, operation system, firmware, software, or any combination of two or all of them. For a hardware implementation, any processing circuitry may be used, which may include one or more processors. For example, the hardware may include one or more of application specific integrated circuits (ASICs), digital signal processors (DSPs), digital signal processing devices (DSPDs), programmable logic devices (PLDs), field programmable gate arrays (FPGAs), processors, controllers, any electronic devices, or other electronic circuitry units or elements designed to perform the functions described above.

If implemented as program code, the functions performed by the transmitting apparatus (device) may be stored as one or more instructions or code on a non-transitory computer readable storage medium such as the memory 210 or any other type of storage. The computer-readable media includes physical computer storage media, which may be any available medium that can be accessed by the computer, or, in general by the processing circuitry 220. Such computer-readable media may comprise RAM, ROM, EEPROM, optical disk storage, magnetic disk storage, semiconductor storage, or other storage devices. Some particular and non-limiting examples include compact disc (CD), CD-ROM, laser disc, optical disc, digital versatile disc (DVD), Blu-ray (BD) disc or the like. Combinations of different storage media are also possible—in other words, distributed and heterogeneous storage may be employed.

The transmitter Tx and receiver Rx of the exemplary implementation in FIG. 1 may use the back-off timer and the determination of the contention window according to the present disclosure. The transmitter Tx and receiver Rx may be implemented in any device such as a base station (e.g. AP) or terminal (e.g., STA), or in any other entity of the communication system CS. A device such as a base station or terminal may implement both Rx and Tx. The present disclosure is not limited to any particular transmitter Tx, receiver Rx and/or interface If implementation. However, it may be applied to some existing communication systems as well as to the extensions of such systems, or to new communication systems as explained above. An existing communication system may, for example, be any device supporting communication according to any IEEE 802.11 standard.

Any of the communication devices described above with references to FIGS. 1 and 2 may provide means in order to carry out the determination of a contention window for a back-off or determining the value of a back-off timer from said contention window as explained above. A processing circuitry within any of these exemplary devices may select, after detecting a collision, a future contention window range having an increased lower bound and an increased upper bound with respect to a lower bound and an upper bound of a current contention window range, and may choose, after a successful transmission, randomly one contention window range from a set of previous contention window ranges as a future contention window range.

A processing circuitry within any of these exemplary devices may select a value of the back-off timer in the determined contention window range. A transmitter within the communication device may transmit a signal after using a back-off timer selected from the contention window range.

The embodiments and exemplary implementations mentioned above show some non-limiting examples. It is understood that various modifications may be made without departing from the claimed subject matter. For example, modifications may be made to adapt the examples to new systems and scenarios without departing from the central concept described herein.

### Selected Embodiments and Examples

According to an embodiment, a method is provided for a determination of a contention window for a back-off timer in a communication device transmitting a signal, comprising: after detecting a collision, selecting a future contention window range having an increased lower bound and an increased upper bound with respect to a lower bound and an upper bound of a current contention window range; and after a successful transmission, choosing randomly one contention window range from a set of previous contention window ranges as a future contention window range.

In an exemplary implementation, the future contention window range and the current contention window range are non-overlapping.

For example, the increased lower bound of the future contention window range is set to the upper bound of the current contention window range.

In an exemplary implementation, the increased upper bound of the future contention window range is set to twice the upper bound of the current contention window range.

For example, a predefined maximum value for the increased upper bound of the future contention window range exists.

In an exemplary implementation, the method is further comprising initializing the current contention window range with a minimum contention window range.

For example, the minimum contention window range is excluded from the set of previous contention window ranges.

In an exemplary implementation, said successful transmission is any successful transmission following detecting the collision within a predefined time or after a predefined number of successful transmissions.

For example, the determination of the contention window is applied in any of the current and future IEEE 802.11 based communication systems.

According to an embodiment, a method is provided for determining the value of a back-off timer in a communication device transmitting a signal, comprising determining of a range of a contention window according to any of the methods described above; selecting a value of the back-off timer in the range; and transmitting the signal when the back-off timer has expired.

In an exemplary implementation, a computer program is provided comprising code instructions stored on a non-transitory, computer-readable medium, which when executed on one or more processors causes the one or more processors to perform steps of any of the methods described above.

According to an embodiment, an apparatus is provided for a determination of a contention window for a back-off timer in a communication device transmitting a signal, comprising: processing circuitry configured to: after detecting a collision, select a future contention window range having an increased lower bound and an increased upper bound with respect to a lower bound and an upper bound of a current contention window range; and after a successful transmission, choose randomly one contention window range from a set of previous contention window ranges as a future contention window range

In an exemplary implementation, the future contention window range and the current contention window range are non-overlapping.

For example, the increased lower bound of the future contention window range is set to the upper bound of the current contention window range.

In an exemplary implementation, the increased upper bound of the future contention window range is set to twice the upper bound of the current contention window range.

For example, a predefined maximum value for the increased upper bound of the future contention window range exists.

In an exemplary implementation, the processing circuitry is further configured to initialize the current contention window range with a minimum contention window range.

For example, the minimum contention window range is excluded from the set of previous contention window ranges.

In an exemplary implementation, said successful transmission is any successful transmission following detecting the collision within a predefined time or after a predefined number of successful transmissions.

For example, the determination of the contention window is applied in any of the current and future IEEE 802.11 based communication systems.

According to an embodiment, a communication device is provided for determining the value of a back-off timer, comprising: any of the apparatuses described above, wherein the processing circuitry is further configured to: select a value of the back-off timer in the contention window range; and a transmitter configured to transmit a signal when the back-off timer has expired.

Moreover, the corresponding methods are provided including steps performed by any of the above-mentioned processing circuitry implementations.

Still further, a computer program is provided, stored on a non-transitory medium, and comprising code instructions which when executed by a computer or by a processing circuitry, performs steps of any of the above-mentioned methods.

According to some embodiments, the processing circuitry and/or the transceiver is embedded in an integrated circuit, IC.

Any of the apparatuses of the present disclosure may be embodied on an integrated chip.

Any of the above-mentioned embodiments and exemplary implementations may be combined.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

1. A method for a determination of a contention window for a back-off timer in a communication device transmitting a signal, comprising:
after detecting a collision, selecting a future contention window range having an increased lower bound and an increased upper bound with respect to a lower bound and an upper bound of a current contention window range; and
after a successful transmission, choosing randomly one contention window range from a set of previous contention window ranges as a future contention window range.

2. The method according to claim 1, wherein the future contention window range and the current contention window range are non-overlapping.

3. The method according to claim 1, wherein the increased lower bound of the future contention window range is set to the upper bound of the current contention window range.

4. The method according to claim 1, wherein the increased upper bound of the future contention window range is set to twice the upper bound of the current contention window range.

5. The method according to claim 1, wherein a predefined maximum value for the increased upper bound of the future contention window range exists.

6. The method according to claim 1, further comprising initializing the current contention window range with a minimum contention window range.

7. The method according to claim 6, wherein the minimum contention window range is excluded from the set of previous contention window ranges.

8. The method according to claim 1, wherein said successful transmission is any successful transmission following detecting the collision within a predefined time or after a predefined number of successful transmissions.

9. The method according to claim 1, wherein the determination of the contention window is applied in any of the current and future IEEE 802.11 based communication systems.

10. A method for determining the value of a back-off timer in a communication device transmitting a signal, comprising
determining of a range of a contention window according to claim 1;
selecting a value of the back-off timer in the range; and
transmitting the signal when the back-off timer has expired.

11. A computer program product comprising instructions stored on a non-transitory, computer-readable medium, which when executed on one or more processors causes the one or more processors to perform the method of claim 1.

12. An apparatus for a determination of a contention window for a back-off timer in a communication device transmitting a signal, comprising:
processing circuitry configured to:
after detecting a collision, select a future contention window range having an increased lower bound and an increased upper bound with respect to a lower bound and an upper bound of a current contention window range; and
after a successful transmission, choose randomly one contention window range from a set of previous contention window ranges as a future contention window range.

13. The apparatus according to claim 12, wherein the future contention window range and the current contention window range are non-overlapping.

14. The apparatus according to claim 12, wherein the increased lower bound of the future contention window range is set to the upper bound of the current contention window range.

15. The apparatus according to claim 12, wherein the increased upper bound of the future contention window range is set to twice the upper bound of the current contention window range.

16. The apparatus according to claim 12, wherein a predefined maximum value for the increased upper bound of the future contention window range exists.

17. The apparatus according to claim 12, wherein the processing circuitry is further configured to initialize the current contention window range with a minimum contention window range.

18. The apparatus according to claim 17, wherein the minimum contention window range is excluded from the set of previous contention window ranges.

19. The apparatus according to claim 12, wherein said successful transmission is any successful transmission following detecting the collision within a predefined time or after a predefined number of successful transmissions.

20. The apparatus according to claim 12, wherein the determination of the contention window is applied in any of the current and future IEEE 802.11 based communication systems.

21. A communication device for determining the value of a back-off timer, comprising:
an apparatus according to claim 12,
wherein the processing circuitry is further configured to:
select a value of the back-off timer in the contention window range; and
a transmitter configured to transmit a signal when the back-off timer has expired.
